(19) United States
(12) Patent Application Publication
(10) Pub. No.: US 2014/0032616 A1
(43) Pub. Date: Jan. 30, 2014

(54) CREATION AND SHARING OF USER ANNOTATIONS

(71) Applicant: John Nack, San Jose, CA (US)

(72) Inventor: John Nack, San Jose, CA (US)

(21) Appl. No.: 12/201,929

(22) Filed: Aug. 29, 2008

(51) Int. Cl. G06F 17/30; G06F 17/00

(52) U.S. Cl. 707/805; 715/230; 707/E17.044; 707/806

(57) ABSTRACT

A method is illustrated comprising receiving annotation data relating to an interface object, the interface object being selectable to invoke functionality of a software application. The method also includes associating the annotation data with the interface object. Further, the method includes storing the annotation data as part of an annotation file. A method is also illustrated that includes receiving an instruction to display annotation data associated with an interface object, the interface object being selectable to invoke functionality of a software application. Moreover, the method includes retrieving the annotation data based upon the association of the annotation data with the interface object. Additionally, the method includes displaying the annotation data proximate to the interface object within a display area.

### COPYRIGHT

A portion of the disclosure of this document includes material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document: Copyright © 2008, Adobe Systems Incorporated. All Rights Reserved.

### TECHNICAL FIELD

The present application relates generally to the technical field of algorithms and programming and, in one specific example, the use of Graphical User Interfaces (GUIs).

### BACKGROUND

GUIs display objects that allow a user to interact with a software application by manipulating and executing functionality associated with the software application. This functionality may be associated with displayed objects. These objects are often ubiquitous, but often times lack detail regarding their functionality or use.

### BRIEF DESCRIPTION OF THE DRAWINGS

Some embodiments are illustrated by way of example and not limitation in the figures of the accompanying drawings in which:

FIG. 1 is a diagram of a system, according to an example embodiment, used to generate an annotation file and to display the contents of the annotation file.

FIG. 2 is a diagram of a system, according to an example embodiment, illustrating storage and retrieval of an annotation file from an annotation server.

FIG. 3 is a diagram of an application interface with annotation functionality, according to an example embodiment, illustrating an object with which annotation data may be associated.

FIG. 4 is a diagram of an application interface with annotation functionality, according to an example embodiment, illustrating creation of a new note.

FIG. 5 is a diagram of an application interface with annotation functionality, according to an example embodiment, illustrating a result of execution of a create new note function.

FIG. 6. is a diagram of an interface for an audio-video recording device, according to an example embodiment, used to record annotation data for an annotation file.

FIG. 7 is a diagram of an application interface with annotation functionality, according to an example embodiment, illustrating a result of execution of a button used to save annotation data.

FIG. 8 is a diagram of an application interface with annotations, according to an example embodiment, showing annotation data provided to a text box.

FIG. 9 is a diagram of an application interface with textual annotations, according to an example embodiment, illustrating all annotation data associated with objects that are a part of an application interface.

FIG. 10 is a diagram of an application interface with annotations, according to an example interface, illustrating a display of additional data in the form of rating data.

FIG. 11 is a diagram of an application interface with annotations, according to an example embodiment, illustrating additional data in the form of recent annotation data related to the object.

FIG. 12 is a block diagram of a computer system, according to an example embodiment, used to generate an annotation file.

FIG. 13 is a block diagram of a computer system, according to an example embodiment, that is used to display annotation data.

FIG. 14 is a flow chart illustrating a method, according to an example embodiment, used to generate an annotation file.

FIG. 15 is a flow chart illustrating a method, according to an example embodiment, used to display annotation data.

FIG. 16 is a flow chart illustrating the execution of a method, according to an example embodiment, used to generate and store an annotation file.

FIG. 17 is a flow chart illustrating execution of an operation, according to an example embodiment, to generate an annotation file.

FIG. 18 is a flow chart illustrating execution of an operation, according to an example embodiment, used to display an annotation file within an application interface.

FIG. 19 is a flow chart illustrating execution of an operation, according to an example embodiment, that retrieves an annotation file based upon a user identifier from an annotation database.

FIG. 20 is a flow chart illustrating the execution of an operation, according to an example embodiment, that checks and sets an annotation display option based upon the user privileges and/or annotation privileges.

FIG. 21 is a tri-stream flow chart illustrating the execution of a method, according to an example embodiment, used to generate and display an annotation file.

FIG. 22 is a Relational Data Scheme (RDS), according to an example embodiment.

FIG. 23 shows a diagrammatic representation of a machine in the form of a computer system, according to an example embodiment, that executes a set of instructions to perform any one or more of the methodologies discussed herein.

### DETAILED DESCRIPTION

In the following description, for purposes of explanation, numerous specific details are set forth in order to provide a thorough understanding of an example embodiment of the present invention. It may be evident, however, to one skilled in the art that the present invention will be practiced without these specific details.

In some example embodiments, a system and method to generate and display annotation data describing an object associated with a software application. This annotation data is displayed proximate to the object where the object is displayed in a display area (e.g., is an interface object) that is part of a GUI. Frame or sub frames are types of display areas. The phrase “associated with a software application” shall be taken to include meaning implemented by the software application. Additional data and privileges are set to control the manner in which the annotation data is displayed. Annotation data may include textual data, audio-video data, or some other suitable type of data generated by a user describing the object. A note is an example annotation. The object may include a graphically displayed software object and associated functionality. An example of an object is a widget, which is an element of the GUI that displays an information arrangement that may be changeable by the user, such as a window or a text box. One characteristic of a widget may be to provide a single interaction point for the direct manipulation of a given kind of data. Functionality provided by a widget may include the direct manipulation of the given kind of data via an operation. Example software applications may include Adobe CREATIVE SUITE®, PHOTOSHOP®, ACROBAT®, COLD FUSION®, DREAMWAVER®, IN-DESIGN®, FLASH®, ILLUSTRATOR®, FIREWORKS®, ENCORE®, FLEX®, or some other suitable software application.

In some example embodiments, the annotation data is displayed proximate to the object where the object is displayed in a display area that is part of the GUI. In one example embodiment, the user may use an input device to focus on (e.g., otherwise select) the object and to associate the annotation data with the object. An input device may include a mouse, light pen, keyboard, touch screen, or other suitable input device. A focus indicates the object of the GUI which is currently selected to receive input via the input device. A graphical point is manipulated by the input device to focus on an object. Using, for example, a mouse, the user may focus on an object, and execute some function to open a menu and text box to generate annotation data relating to the object. This function may include a mouse-over function, left-click, right-click function, or some other suitable function. This annotation data may be displayed within the GUI proximate to the object. Associating the annotation data with the object may include relating the annotation data and the object in a database using a numeric value such as a key value.

In some example embodiments, additional data and privileges are set to control the manner in which the annotation data is displayed. Additional data may include an annotation identifier (ID), a user ID, user name, an object ID, a user profile, privileges associated with the annotation data, privileges associated with the user, rating data, graphics data, follow-up data, and other suitable data. This additional data, as will be more fully discussed below, may be generated and stored as part of an annotation file. The annotation file may be a data file formatted as a character delimited flat file, an eXtensible Markup Language (XML) file, or other suitably formatted file. Further, the annotation file may be data stored as an attribute of a software object, or as a data in a data structure. The annotation file may be retrieved by the software application and displayed to a user.

In some example embodiments, a user may use an input device to guide a graphical pointer to select (e.g., focus on) an object displayed within a GUI as part of a software application. The user may execute a right-click function to open a display area (e.g., a popup window) that prompts the user to enter annotation data regarding the object. This annotation data may include statements such as “Use this tool when smoothing pixilation in an image.” Additionally, the user may be prompted to provide additional data including the software application with which the annotation is to be associated and the setting of privileges for the annotation data (e.g., who has the privilege to view the annotation data, share the annotation data.). The above referenced additional data may be generated and associated with the annotation data, and the annotation data and additional data may be assembled into an annotation file. This annotation file may be accessed by subsequent users and the annotation data displayed to subsequent users such that when a subsequent user wants to use the object with which the annotation data is associated, the user may be prompted with the message, “Use this tool when smoothing pixilation in an image.” The various example systems, GUIs, logic, database associated with the system and method are illustrated below.

### Example System

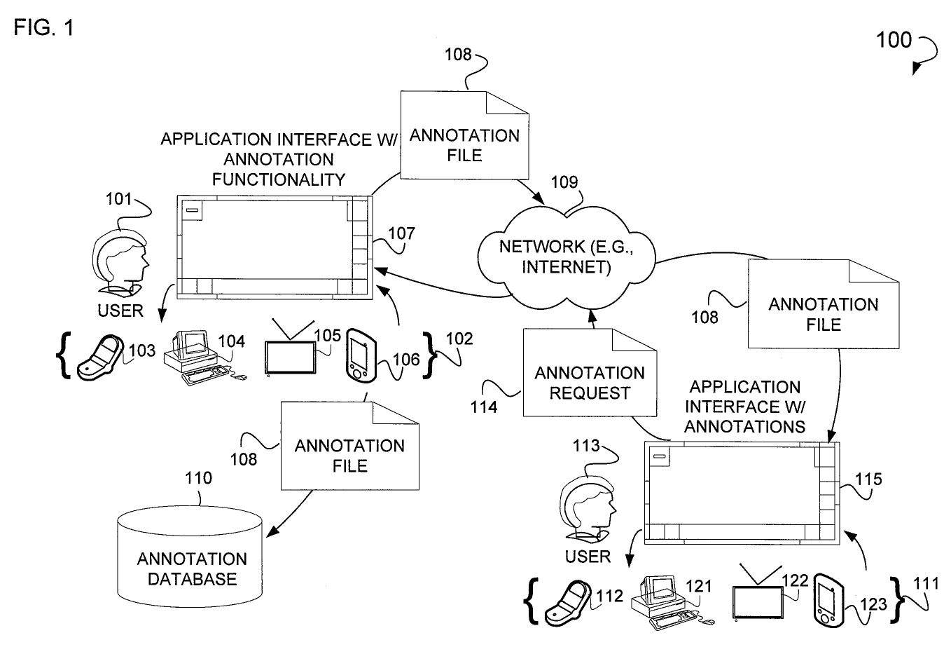

FIG. 1 is a diagram of an example system 100 used to generate an annotation file and to display the contents of the annotation file in conjunction with an interface object of a software application. Shown is a user 101 using one or more devices 102 to generate an annotation file 108. These one or more devices 102 include a cell phone 103, a computer system 104, a television or monitor 105, a Personal Digital Assistant (PDA) 106, or a smart phone (not shown). These one or more devices 102 generate an software application interface with annotation functionality 107 (referenced herein as an application interface 107) in the form of a GUI. The user 101 uses the application interface 107 to generate the annotation file 108. This annotation file 108 is transmitted across a network 109 by the one or more devices 102. Alternatively, the annotation file 108 is stored by the one or more devices 102 into an annotation database 110. This annotation database 110 may be some type of persistent or non-persistent storage medium or media. Further, the annotation database 110 may be a native or non-native database that is operatively connected to the one or more devices 102. “Operatively connected” may include a logical or physical connection. In some example embodiments, a user 113 uses one or more devices 111 to generate an annotation request 114. These one or more devices 111 may include a cell phone 112, a computer system 121, a television or monitor 122, a PDA 123, or a smart phone (not shown). These one or more devices 111 generate and display an application interface 115 with annotations. This application interface 115 with annotations is used to generate the annotation request 114 that is transmitted across the network 109 by the one or more devices 111. The annotation request 114 is received by the one or more devices 102, and the annotation file 108 transmitted back across network 109 to be received by the one or more devices 111. This annotation file 108, as will be more fully illustrated below, is processed and the annotation data and additional data included therein displayed for viewing to the user 113.

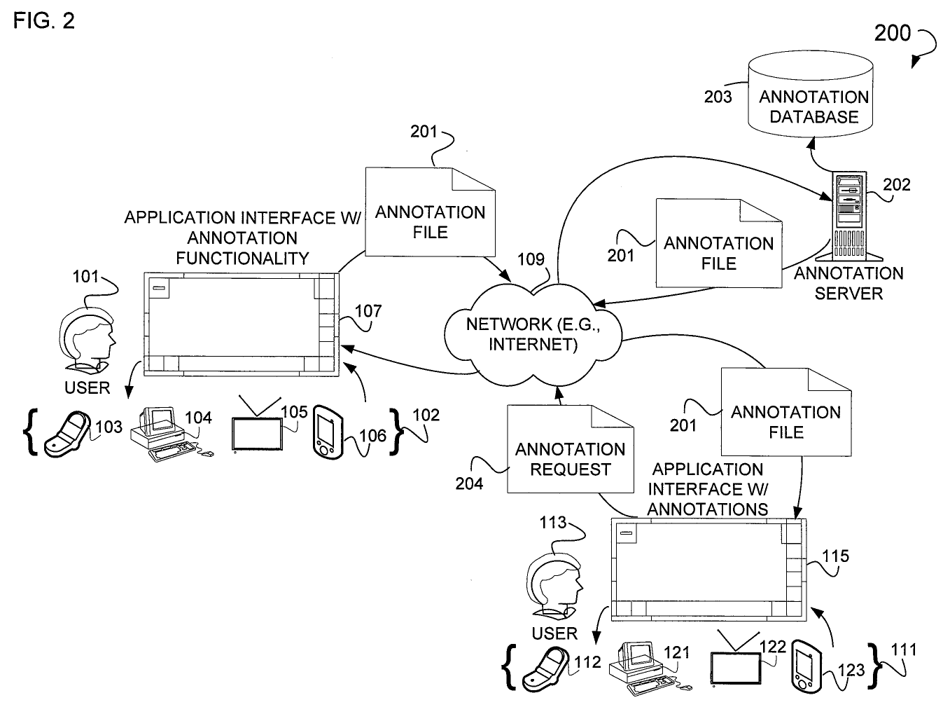

FIG. 2 is a diagram of an example system 200 illustrating the storage and retrieval of an annotation file 201 from an annotation server 202. Shown is the previously illustrated one or more devices 102 that are used in conjunction with an application interface 107 to generate and transmit an annotation file 201. This annotation file 201 is transmitted across a network 109 to be received by the annotation server 202. This annotation server 202 stores the annotation file 201 into an annotation database 203. This annotation database 203 may be some type of persistent or non-persistent storage medium that may be operatively connected to the annotation server 202. The annotation database 203 may be a native or normative storage medium.

In some example embodiments, the user 113 may generate an annotation request 204 using the one or more devices 111 in conjunction with an application interface 115 with annotations. This annotation request 204 is transmitted across the network 109 to be received by the annotation server 202. This annotation server 202 retrieves the annotation file 201 from the annotation database 203. The annotation file 201 is transmitted back across the network 109 to be received by the one or more devices 111. This annotation file 201 is processed and the annotation data and additional data included therein displayed for viewing by the user 113.

### Example Interfaces

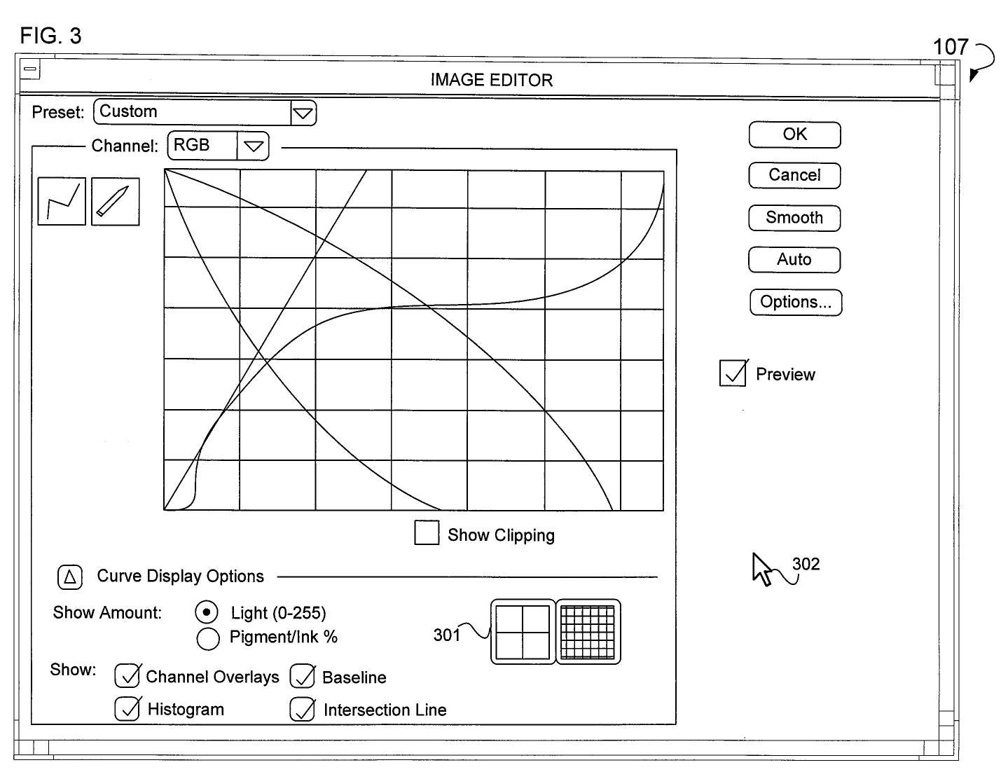

FIG. 3 is a diagram of an example application interface 107 illustrating an object with which annotation data may be associated. Shown is an application interface 107 that displays, for example, a GUI for a particular software application. Displayed as a part of the software application is an object 301. Further, shown is a graphical pointer 302. As will be more fully illustrated below, the user 101 may use an input device to manipulate the graphical pointer 302 to focus upon the object 301. Once focus occurs, annotation data is generated and associated with the object 301.

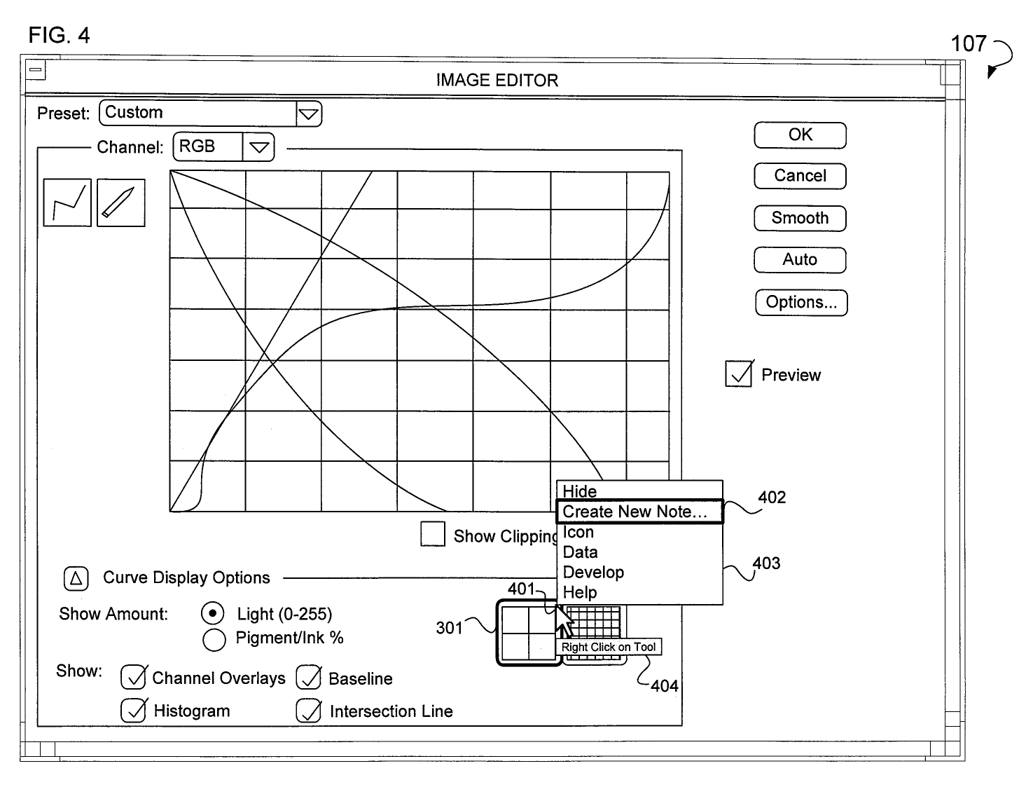

FIG. 4 is a diagram of an example application interface 107 illustrating the creation of a new note. A new note may be a textual note or audio-video note regarding the object 301 that did not previously exist. Shown is the previously illustrated object 301. Further, a graphical pointer 401 is shown that is focused upon the object 301. In some example embodiments, a tool tip 404 is displayed that instructs the user 101 as to how to implement the functionality associated with the graphical pointer 401 to generate a new note. A pop-up menu 403 is generated to display certain functions associated with the graphical pointer 401. Here, for example, a create new note function 402 is shown and selected by the user 101.

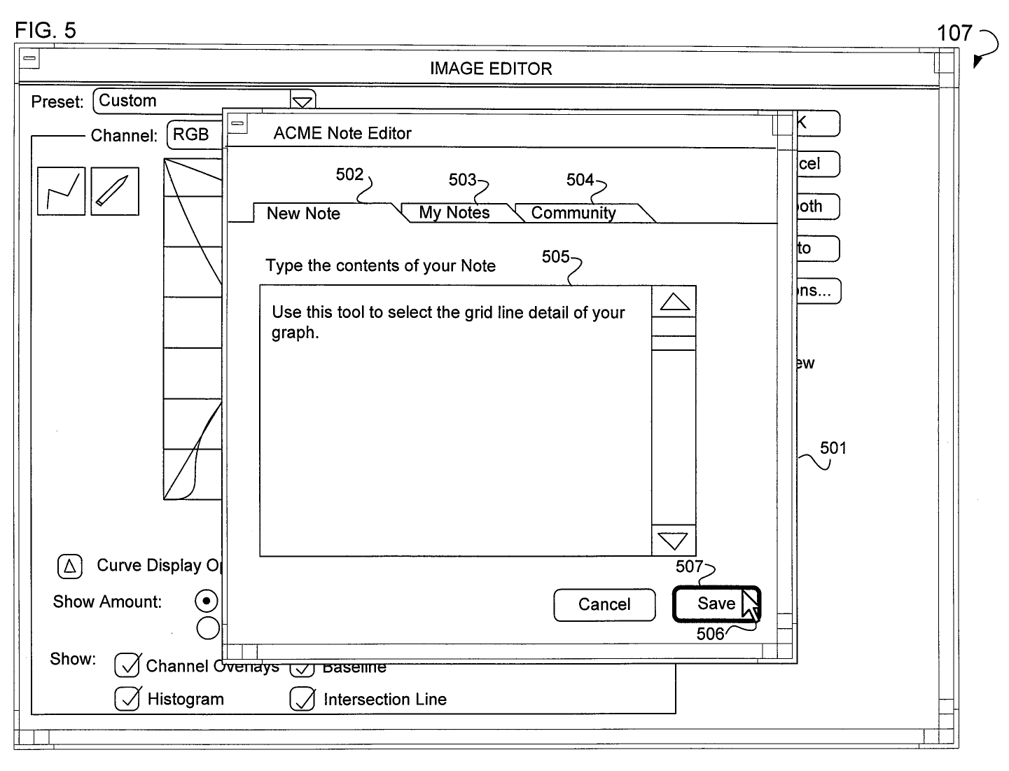

FIG. 5 is a diagram of an example application interface 107 illustrating a result of the execution of a create new note function 402. Shown is a pop-up window 501 that includes a number of objects that are used during the course of creating a new note to be associated with, for example, the object 301. A tab 502, when selected, displays a text box 505 into which annotation data is entered. Here, annotation data in the form of the statement “Use this tool to select the gridline detail of your graph” has been entered into the text box 505. Also shown are additional tabs, titled “My Notes” 503 and “Community” 504. Using the graphical pointer 506, the tabs 502 through 504 are selected (e.g., focused upon) as is the text box 505. Further, a save button 507 is shown that allows the user 101 to save the annotation data entered into the text box 505.

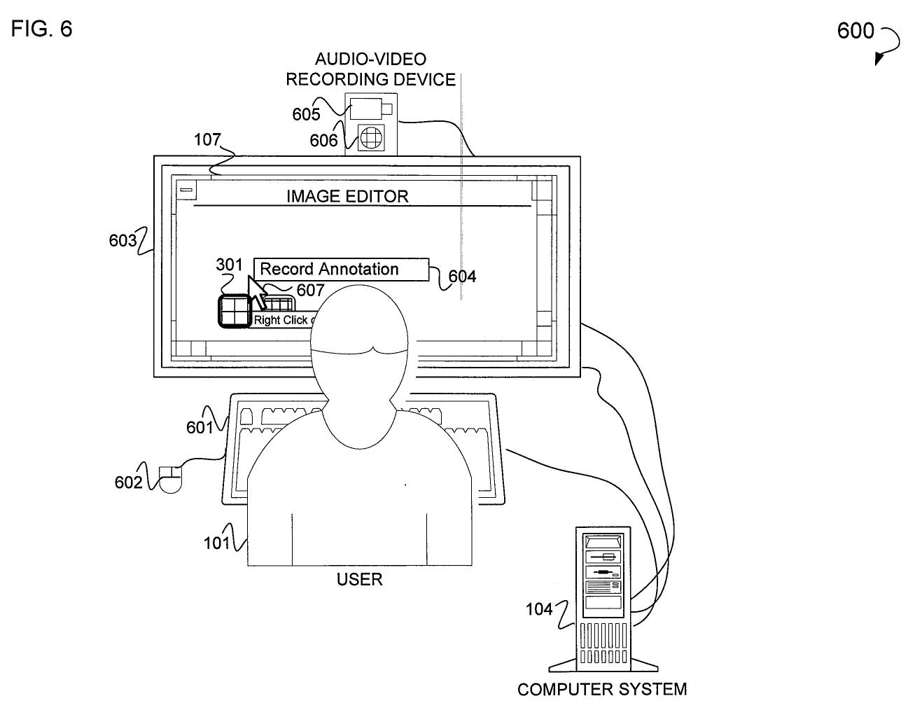

FIG. 6. is a diagram of an example interface for an audio-video recording device 600 used to record annotation data for the annotation file 108. Shown is the user 101 who, using the computer system 104 in conjunction with a keyboard 601, mouse 602, camera 605, and microphone 606, generates annotation data for the object 301. In one example embodiment, the user 101 selects the object 301 using the graphical pointer 607. Selection is facilitated by a function associated with the mouse 602 such as a left-click function, a right-click function, or mouse-over function. A popup window 604 appears that allows the user 101 to select a button displayed in the popup window 604 to begin recording an annotation regarding the object 301. The annotation is recorded through the use of the camera 605 and microphone 606. The object 301, graphical pointer 607, and popup window 604 are displayed within the application interface 107 that is further provided as part of the display 603. In some example embodiments, the annotation data generated through the use of the audio-video recording device 600 is formatted using a codec including Moving Picture Experts Group (MPEG), TrueMotion (VP6), or Windows Media Video (WMV). The annotation data is transmitted as part of the annotation file 108.

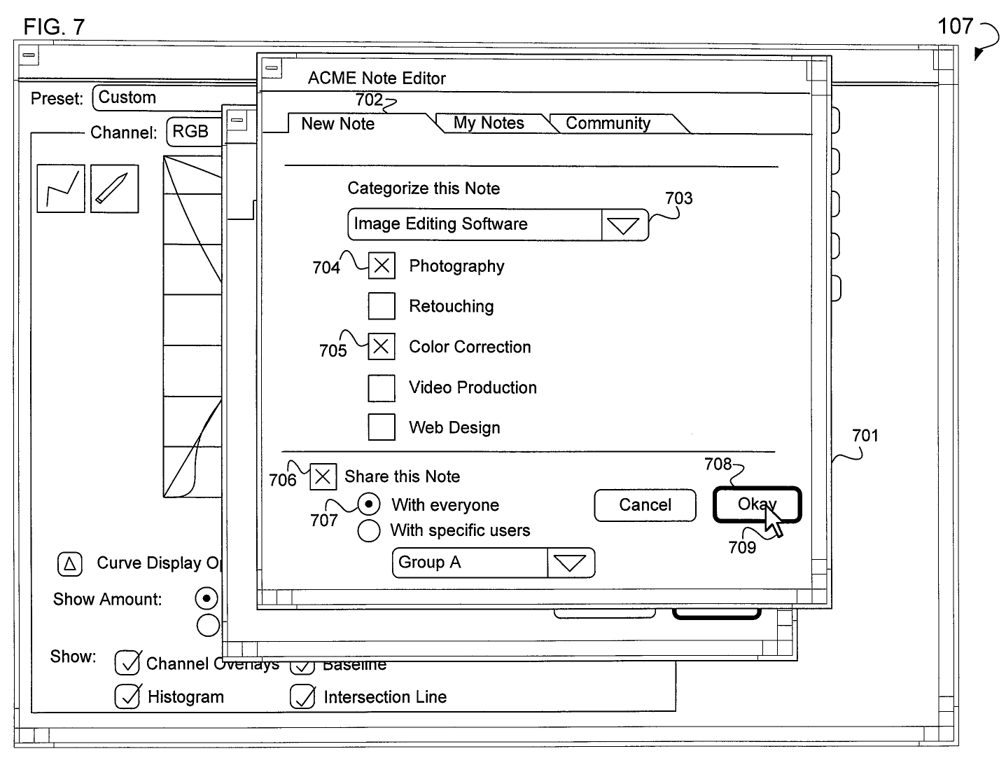

FIG. 7 is a diagram of an example application interface 107 illustrating the result of the execution of the save button 507 used to save annotation data. Shown is a pop-up window 701 including a number of objects. These objects include, for example, a tab 702, a drop-down menu 703, a check box 704, a check box 705, a check box 706, a radio button 707 and an object 708. With regard to the tab 702, the user 101 may use the graphical pointer 709 to select the tab 702. Where tab 702 is selected, the drop-down menu 703 is displayed. This drop-down menu 703 allows the user 101 to categorize the note and associated annotation data that is created via the pop-up window 501 as illustrated in FIG. 5. This categorization includes, for example, associating the note with imaging software. Further, when tab 702 is executed, a check box 704 is displayed as is a check box 705. Check box 704, titled “Photography,” allows for the user 101 to further categorize the annotation data inputted as a part of the text box 505. Further, a check box 705 may allow for further categorization, wherein the user 101 is able to categorize the annotation data entered into the text box 505 as “Color Correction” related. Check box 706 allows a share privilege to be established by the user 101. Further, the share privilege can be made more specific by selection of, for example, radio button 707. In some example embodiments, where the annotation data is categorized and the sharing privileges established, an object 708 is executed using the graphical pointer 709. The graphical pointer 709 is used to store the categorization data and share data as a part of the annotation file 108.

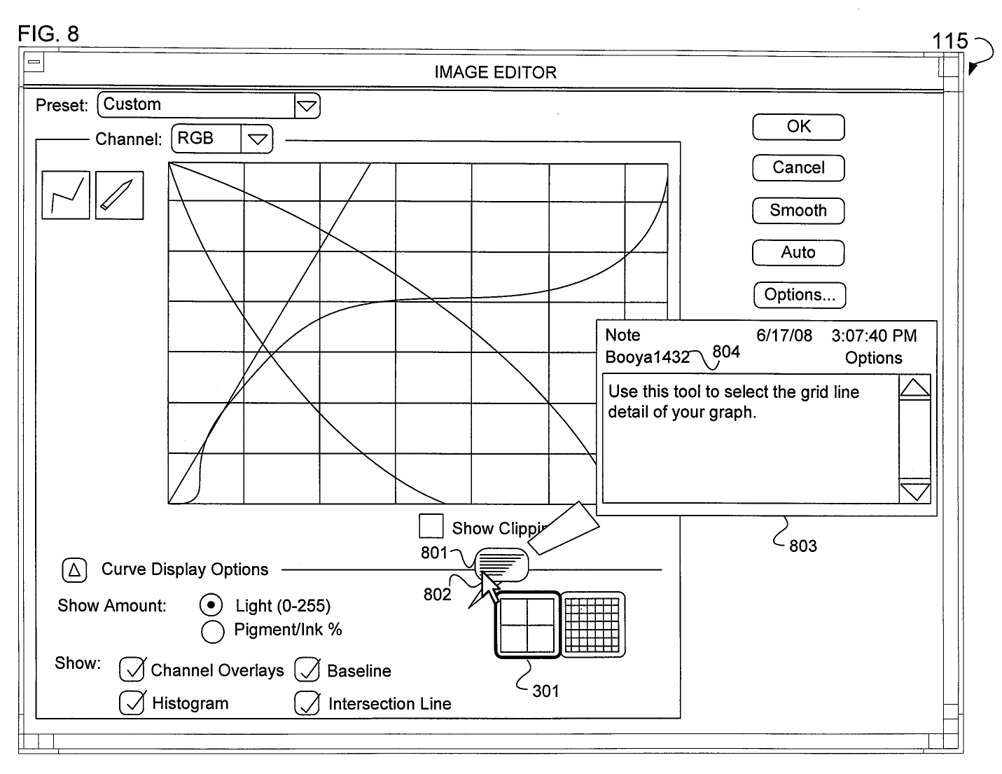

FIG. 8 is a diagram of an example application interface 115 with annotations showing the annotation data provided to text box 505 as displayed. Shown is an annotation data icon 801 that, when executed via the use of a graphical pointer 802, generates a pop-up window 803. Included within the pop-up window 803 is the previously provided annotation data (see e.g., text box 505) and a user ID 804. The annotation data icon 801 is located proximate to the object 301. When focused upon using the graphical pointer 802, and executing a function associated with the graphical pointer 802, the pop-up window 803 is generated.

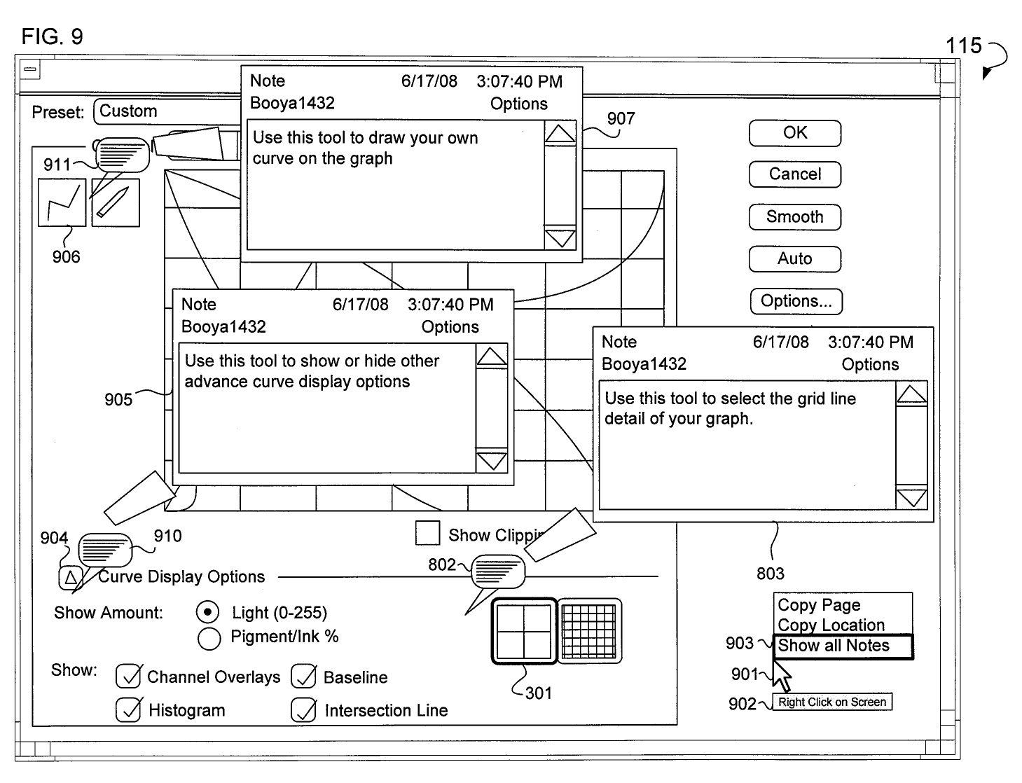

FIG. 9 is a diagram of an example application interface 115 with annotations illustrating all annotation data associated with objects that are a part of the application interface 115 with annotations. Shown is a graphical pointer 901 that, through executing a function associated with the graphical pointer 901, facilitates the display of a menu 903. Included within the menu 903 is an option titled “Show all Notes.” A tool tip 902 is associated with the graphical pointer 901. This tool tip 902 instructs the user 113 as to how to access the annotation data associated with each of the objects displayed within the application interface 115 with annotations. Here, the “Show all Notes” option has been selected to show all notes associated with objects in the application interface 115 with annotations. In example cases where the “Show all Notes” option is selected, pop-up windows 803, 905 and 907 are displayed. These pop-up windows 803, 905 and 907 are associated with objects 301, 904 and 906 via data icons 801, 910 and 911, respectively.

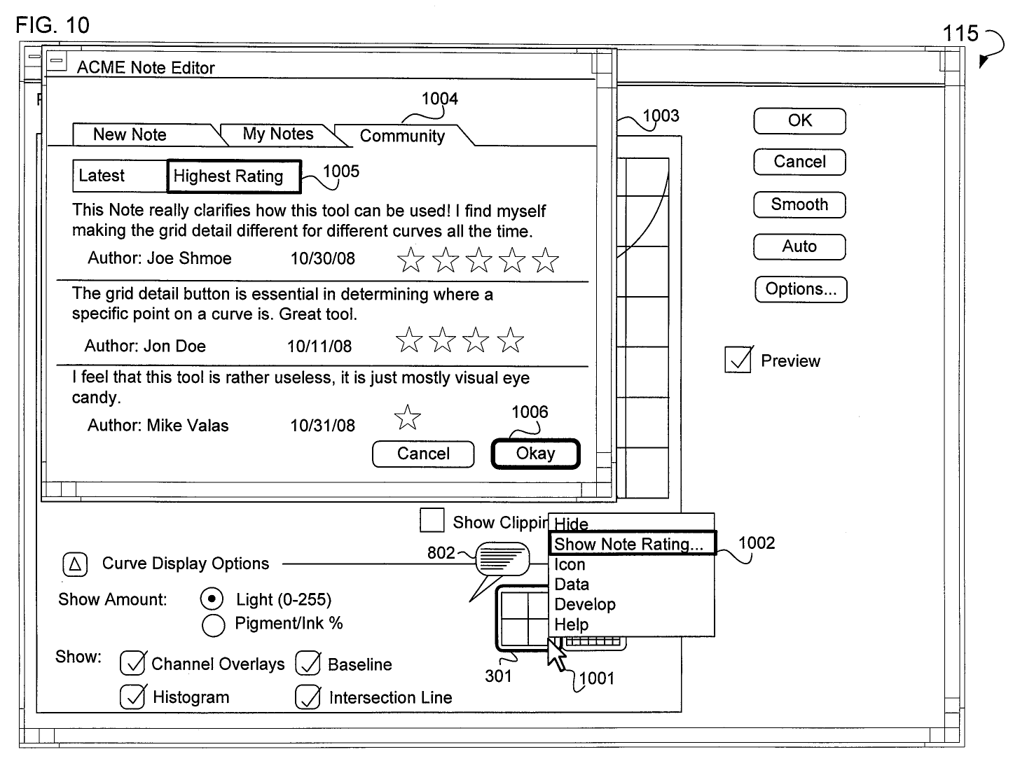

FIG. 10 is a diagram of an example application interface 115 with annotations illustrating a display of additional data in the form of rating data. Rating data is a user-generated evaluation of the annotation data. This evaluation may be positive or negative as represented using an icon. Shown is a graphical pointer 1001 that, when used to focus upon the object 301, displays a menu 1002. This focus may include the use of a function associated with the graphical pointer 1001. Included in the menu 1002 is a “Show Note Rating” selection option. In cases where the “Show Note Rating” selection option is selected using the graphical pointer 1001, a pop-up window 1003 is shown. Included within the pop-up window 1003 is a tab 1004. Where the tab 1004 is selected using the graphical pointer 1001, a highest rating button 1005 may be selected, again using the graphical pointer 1001. The highest rating button 1005 shows the highest ratings associated with the note generated for the object 301. These ratings may include annotation data, the author of the annotation data at the time the annotation data was generated, and a rating system in the form of icons such as stars (“*”) associated with a particular annotation data. A button 1006 may also be displayed as a part of the pop-up window 1003. The button 1006, when selected, allows the user 113 to close the pop-up window 1003.

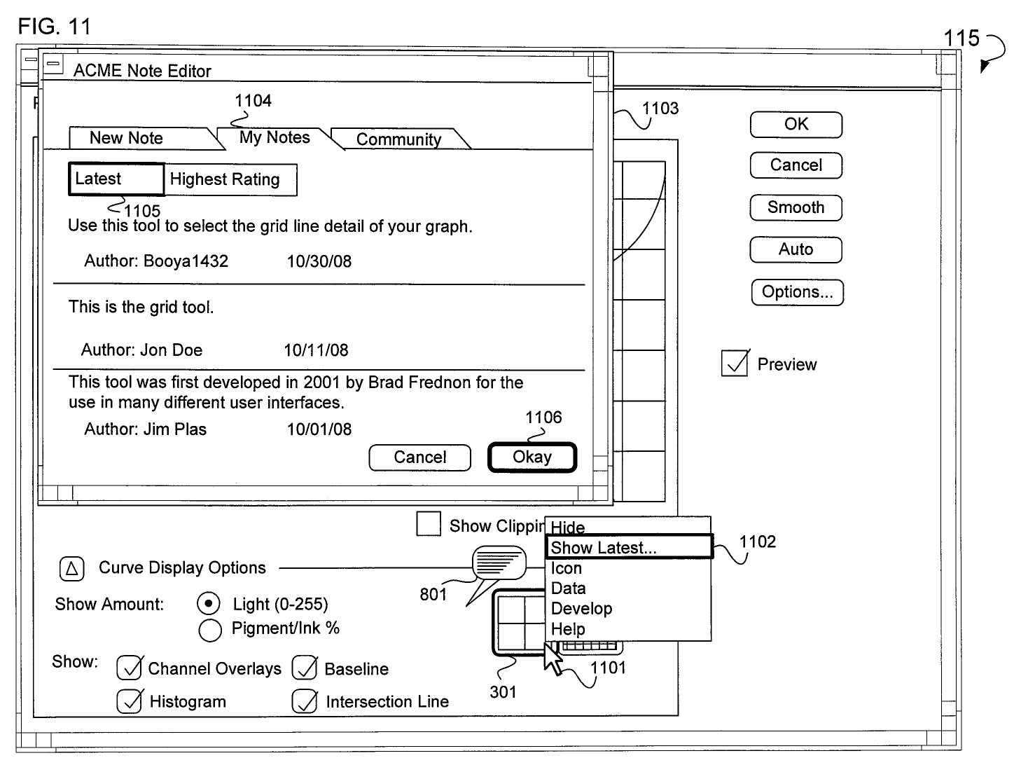

FIG. 11 is a diagram of an example application interface 115 with annotations illustrating additional data in the form of recent annotation data related to the object 301. Shown is a graphical pointer 1101 that, when used to focus upon the object 301, generates a menu 1102. Included as a part of the menu 1102 is a “Show Latest” note option. The “Show Latest” note option is executed to generate a pop-up window 1103. This pop-up window 1103 may include a tab 1104. Included as a part of the tab 1104 is a button 1105 that allows the user 113 to select the latest annotation data generated with respect to the object 301. “Latest” may include a temporal definition in the form of the most recent notes. Also shown is a button 1106 that, when selected, allows the user 113 to close the pop-up window 1103.

### Example Logic

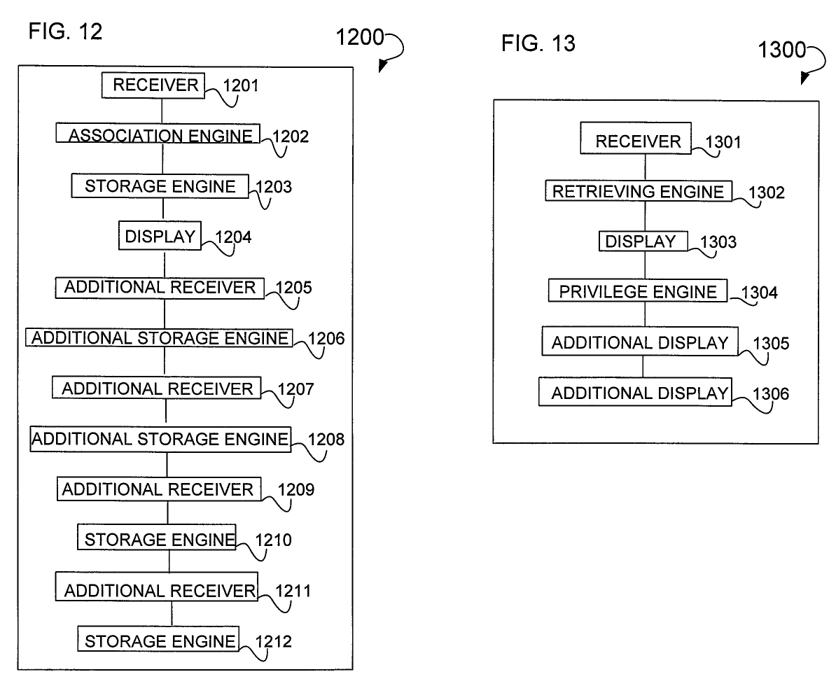

FIG. 12 is a block diagram of an example computer system 1200 that is used to generate an annotation file. The blocks shown herein may be implemented in software, firmware, or hardware. These blocks may be directly or indirectly communicatively coupled via a physical or logical connection. The computer system 1200 may be the one or more devices 102. Shown are blocks 1201 through 1212. A receiver 1201 is illustrated to receive annotation data that relates to an interface object, the interface object being selectable to invoke functionality of a software application. Communicatively coupled to the receiver 1201 is an association engine 1202 to associate the annotation data with the interface object. Communicatively coupled to the association engine 1202 is a storage engine 1203 to store the annotation data as part of an annotation file. In some example embodiments, the annotation data relating to the interface object describes the interface object. In some example embodiments, the annotation data describes a recommended situation for functionality that is invoked by a selection of the interface object. Further, in some example embodiments, the annotation data includes at least one of textual data, or audio-video data. In some example embodiments, the interface object is presented in a display area, the display area included in a GUI. Communicatively coupled to the storage engine 1203 is a display 1204 to display the annotation data proximate to the interface object within a display area, the display area including a GUI. Communicatively coupled to the display 1204 is an additional receiver 1205 to receive rating data that provides a user-based rating for the annotation data. Communicatively coupled to the additional receiver 1205 is an additional storage engine 1206 to store the rating data as part of the annotation file. Communicatively coupled to the additional storage engine 1206 is an additional receiver 1207 to receive follow-up data that includes additional information relating to the interface object. Communicatively coupled to the additional receiver 1207 is an additional storage engine 1208 to store the follow-up data as part of the annotation file. In some example embodiments, the follow-up data includes additional information providing specifics with respect to the annotation data. Communicatively coupled to the additional storage engine 1208 is an additional receiver 1209 to receive graphics data related to the annotation data. Communicatively coupled to the additional receiver 1209 is a storage engine 1210 to store the graphics data as part of the annotation file. Communicatively coupled to the storage engine 1210 is an additional receiver 1211 to receive privilege data that sets a user privilege for the annotation data. Communicatively coupled to the additional receiver 1211 is a storage engine 1212 to store the privilege data as part of the annotation file. In some example embodiments, the additional receivers 1205, 1207, 1209, and 1211 may be implemented as the receiver 1201. In some example embodiments, the additional storage engines 1206, 1208, 1210, and 1212 may be implemented as the storage engine 1203.

FIG. 13 is a block diagram of an example computer system 1300 that is used to display annotation data. The blocks shown herein may be implemented in software, firmware, or hardware. These blocks may be directly or indirectly communicatively coupled via a physical or logical connection. The computer system 1300 may be the one or more devices 111, or annotation server 202. Shown are blocks 1301 through 1309 that include a receiver 1301 to receive an instruction to display annotation data associated with an interface object, the interface object being selectable to invoke functionality of a software application. Communicatively coupled to the receiver 1301 is a retrieving engine 1302 to retrieve the annotation data based upon the association of the annotation data with the interface object. Communicatively coupled to the retrieving engine 1302 is a display 1303 to display the annotation data proximate to the interface object within a display area. In some example embodiments, wherein the interface object includes an object presented in the display area, the display area included in a GUI. Communicatively coupled to the display 1303 is a privilege engine 1304 to set a privilege for the annotation data. Communicatively coupled to the privilege engine 1304 is an additional display 1305 to display the annotation data proximate to the interface object based upon the privilege. In some example embodiments, the privilege includes at least one of an edit privilege, a delete privilege, an add annotation privilege, a share privilege, or a rating privilege. Communicatively coupled to the additional display 1305 is an additional display 1306 to display within the display area at least one of rating data related to the annotation data, additional annotation data generated prior, in time, to the annotation data, follow-up data related to the annotation data, or graphical data related to the annotation data. In some example embodiments, the additional display 1305 and additional display 1306 may be implemented as the same display 1303.

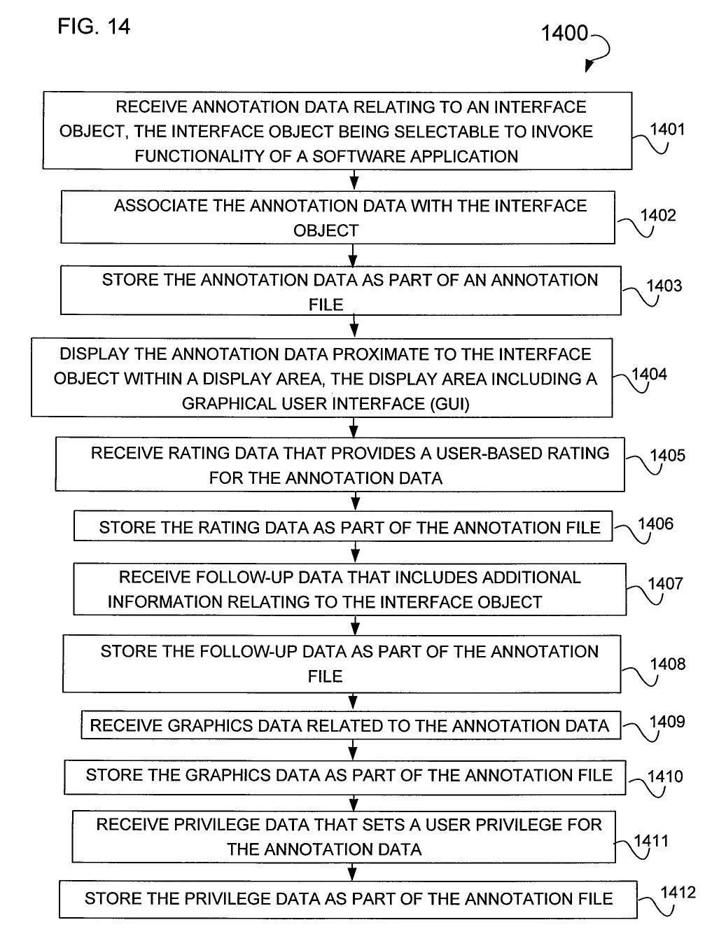

FIG. 14 is a flow chart illustrating an example method 1400 to generate an annotation file. Shown are various operations 1401 through 1412 that may be executed upon the one or more devices 102. Shown is an operation 1401 that, when executed by the receiver 1201, receives annotation data relating to an interface object, the interface object being selectable to invoke functionality of a software application. Operation 1402 is executed by the association engine 1202 to associate the annotation data with the interface object. Operation 1403 is executed by the storage engine 1203 to store the annotation data as part of an annotation file. This annotation data may be stored into the annotation database 110, and/or into a persistent or non-persistent memory. In some example embodiments, the annotation data relating to the interface object describes the interface object. Additionally, in some example embodiments, the annotation data describes a recommended situation for functionality that is invoked by a selection of the interface object. Further, In some example embodiments, the annotation data includes at least one of textual data, or audio-video data. The interface object may be presented in a display area, the display area included in a GUI. Operation 1404 is executed by the display 1204 to display the annotation data proximate to the interface object within a display area, the display area including a GUI. Operation 1405 is executed by the additional receiver 1205 to receive rating data that provides a user-based rating for the annotation data. Operation 1406 is executed by the additional storage engine 1206 to store the rating data as part of the annotation file. Operation 1407 is executed by the additional receiver 1207 to receiving follow-up data that includes additional information relating to the interface object. Operation 1408 is executed by the additional storage engine 1208 to store the follow-up data as part of the annotation file. In some example embodiments, the follow-up data includes additional information providing specifics with respect to the annotation data. Operation 1409 is executed by the additional receiver 1209 to receive graphics data related to the annotation data. Operation 1410 is executed by the storage engine 1210 to store the graphics data as part of the annotation file. Operation 1411 is executed by the additional receiver 1211 to receive privilege data that sets a user privilege for the annotation data. Operation 1412 is executed by the storage engine 1212 to store the privilege data as part of the annotation file.

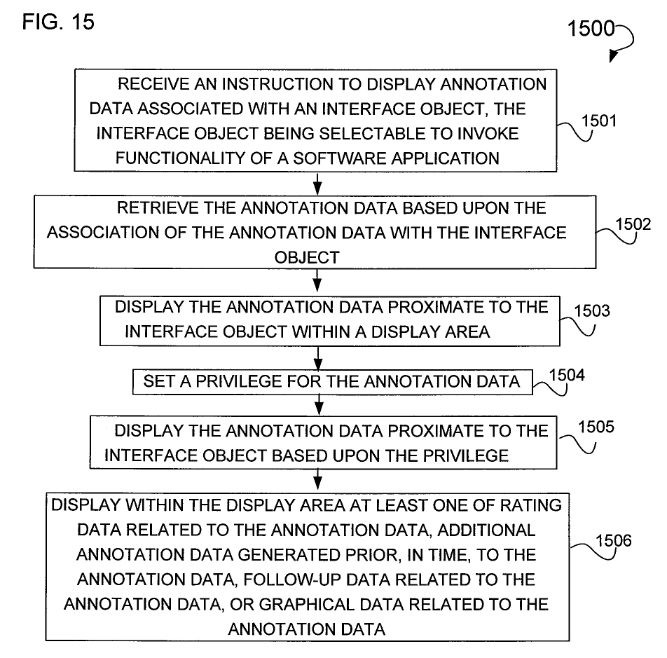

FIG. 15 is a flow chart illustrating an example method 1500 used to display annotation data. Shown are various operations 1501 through 1506 that may be executed by the one or more devices 111 or the annotation server 202. Operation 1501 is executed by the receiver 1301 to receive an instruction to display annotation data associated with an interface object, the interface object being selectable to invoke functionality of a software application. Operation 1502 is executed by the retrieving engine 1302 to retrieve the annotation data based upon the association of the annotation data with the interface object. Operation 1503 is executed by the display 1303 to display the annotation data proximate to the interface object within a display area. In some example embodiments, the interface object includes an object presented in the display area, the display area included in a GUI. Operation 1504 is executed by the privilege engine 1304 to set a privilege for the annotation data. Operation 1505 is executed by the additional display 1305 to display the annotation data proximate to the interface object based upon the privilege. In some example embodiments, the privilege includes at least one of an edit privilege, a delete privilege, an add annotation privilege, a share privilege, or a rating privilege. Operation 1506 is executed by the additional display 1306 to display within the display area at least one of rating data related to the annotation data, additional annotation data generated prior, in time, to the annotation data, follow-up data related to the annotation data, or graphical data related to the annotation data.

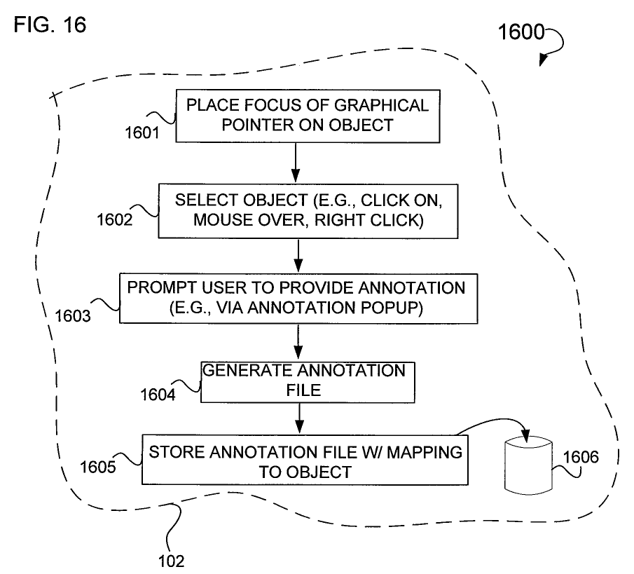

FIG. 16 is a flow chart illustrating the execution of an example method 1600 used to generate and store the annotation file 108. Shown are various operations 1601 through 1605 and a database 1606. As illustrated, the various operations 1601 through 1605 are executed by one or more of the devices 102. This database 1606 may be a persistent or non-persistent data store that may natively or non-natively store data for the one or more devices 102. Operation 1601, when executed, places the focus of a graphical pointer on an object. This graphical pointer may be the previously illustrated graphical pointer 302, 401, 506 or 609. The object may be the object 301. An operation 1602 is executed that selects an object. This selection of an object may be facilitated through, for example, a click on function, mouse-over function, right-click function, left-click function, or some other function associated with the previously referenced graphical pointers. Operation 1603 is executed to prompt the user 101 to provide annotation data via some type of input object (e.g., pop-up window 501). Operation 1604 is executed to generate the annotation file 108. Operation 1605 is executed to store the annotation file with a mapping to the object 301. This storage may include storing the annotation file 108 into the annotation database 110 or, as illustrated here, the database 1606. This annotation file 108 may also be stored to the annotation database 203 (see e.g., FIG. 2). In some example embodiments, the annotation file 108 is mapped to a specific object wherein the specific object is differentiated from other objects associated with a software application based upon some type of unique identifying value (e.g., an object ID). A unique identifying value, which is more fully illustrated below, may include a unique identifying integer value associated with the object.

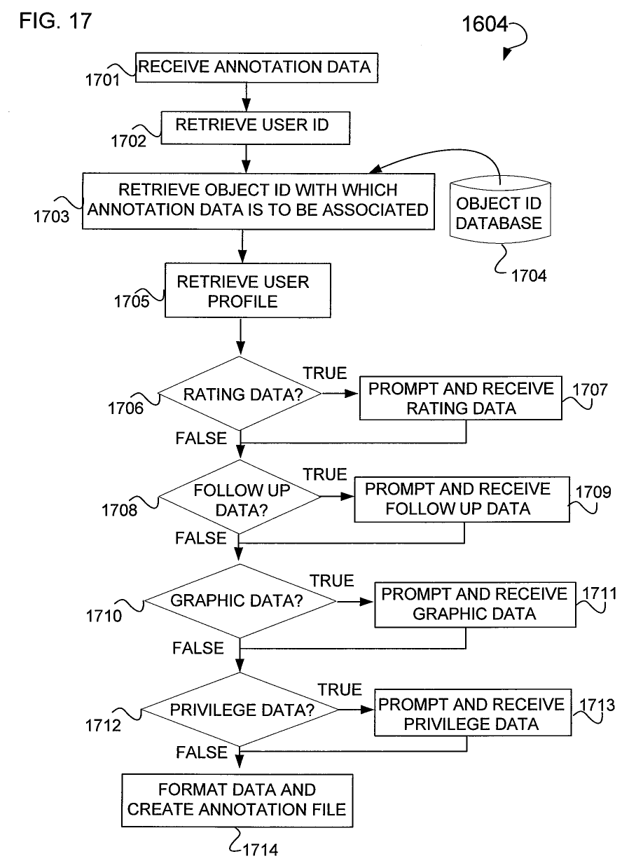

FIG. 17 is a flow chart illustrating the execution of operation 1604. Shown is an operation 1701 that, when executed, receives annotation data. This annotation data is provided to, for example, the pop-up window 501 by the user 101. Further, the annotation data is provided via the audio-video recording device 600. Included in the annotation data is an identifier for the object for which the annotation data has been generated. This identifier is a place holder value that is replaced with an object ID. An optional operation 1702 is executed to retrieve a user ID for, for example, the user 101. Operation 1703 is executed to retrieve an object ID, from the object ID database 1704, with which the annotation data is to be associated. This object ID replaces the placeholder value. An optional operation 1705 is executed that retrieves a user profile for, for example, the user 101. This user profile is retrieved from the one or more devices 102, or from the annotation server 202.

In some example embodiments, a decisional operation 1706 is executed that determines whether rating data is to be associated with the annotation data. Where decisional operation 1706 evaluates to “true,” an operation 1707 is executed, that prompts the user 101 for rating data. This prompting may be in the form of presenting to the user 101 a pop-up window requesting that rating data be provided. Rating data may be in the form of selecting a numeric value, an iconic value (e.g., represented as stars (“*”)), or some other suitable way to rate annotation data. Where decisional operation 1706 evaluates to “false,” a decisional operation 1708 is executed. Decisional operation 1708 determines whether follow-up data is to be provided for the annotation data. In cases where decisional operational 1708 evaluates to “true,” an operation 1709 is executed, and the user 101 is prompted for follow-up data. Follow-up data is received through the execution of operation 1709. Operation 1709 prompts the user 101 with a pop-up window into which the user 101 may provide the follow-up data. Follow-up data includes, for example, additional information providing specifics with respect to the annotation data. Specifics may be in the form of a Uniform Resource Locator (URL) value (e.g., a web link to data relating to the annotation data), additional textual data, additional audio-visual data, or other suitable data providing more specifics as to the annotation data. In cases where decisional operation 1708 evaluates to “false,” a decisional operation 1710 is executed. This operation 1710, when executed, determines whether graphical data is to be provided with respect to the annotation data. In cases where decisional operation 1710 evaluates to “true,” an operation 1711 is executed that prompts the user 101 to provide graphical data. This prompting may be in the form of a pop-up window provided to the user 101 prompting the user 101 for information related to graphical data. Graphical data may be in the form of an MPEG file, a Joint Photographic Experts Group (JPEG) file, a script (e.g., a Shock Wave Flash (SWF) script, JavaScript, Visual Basic Script (VBScript)), or some other suitably formatted file. In cases where decisional operation 1710 evaluates to “false,” a decisional operation 1712 is executed. Decisional operation 1712 determines whether or not there are privileges associated with the annotation data and additional data associated therewith. In cases where decisional operation 1712 evaluates to “true,” an operation 1713 is executed that prompts the user 101 for the privilege data (see e.g., pop-up window 701, check box 706 and radio button 707). In cases where decisional operation 1712 evaluates to “false,” an operation 1714 is executed that formats the data provided via operations 1707, 1709, 1711 and 1713 to create the annotation file 108.

In some example embodiments, the annotation file 108 or annotation file 201 is written in XML. An example of the annotation file 108 or annotation file 201, and the data described therein, is provided in the following XML pseudo code:

```
<ANNOTATION FILE>
    <ANNOTATION ID> ED32214 </ANNOTATION ID>
    <ANNOTATION DATA> “Use this tool to select the gridline
detail of your graph” </ANNOTATION DATA>
    <USER ID> “Booya1432” </USER ID>
    <USER NAME> “Joe” </USER NAME>
    <OBJECT ID> DD32546 </OBJECT ID>
    <USER PROFILE>
        <DEPARTMENT> Graphics </DEPARTMENT>
        <PASSWORD> “Printf_law1” </PASSWORD>
        <PRIVILEGES>
            <EDIT> Y </EDIT>
            <DELETE> N </DELETE>
            <ADD ANNOTATION> Y </ADD ANNOTATION>
            <SHARE> Y </SHARE>
            <RATING> Y </RATING>
        </PRIVILEGES>
    <RATING DATA> “***” </RATING DATA>
    <GRAPHICS> WWW.IMAGEEDITOR.COM/COMMENTS.SWF
</GRAPHICS>
    <FOLLOWUP> WWW.IMAGEEDITOR.COM/COMMENTS.HTM
</FOLLOWUP>
</ANNOTATION FILE>
```

In some example embodiments, the annotation data is textual data, or audio-video data. In cases where audio-video data is provided, the above annotation data tag (e.g., <ANNOTATION DATA>) may include a URL link to an audio-video file. In some example cases, an actual file including digital content is provided as part of the annotation file 108 or annotation file 201.

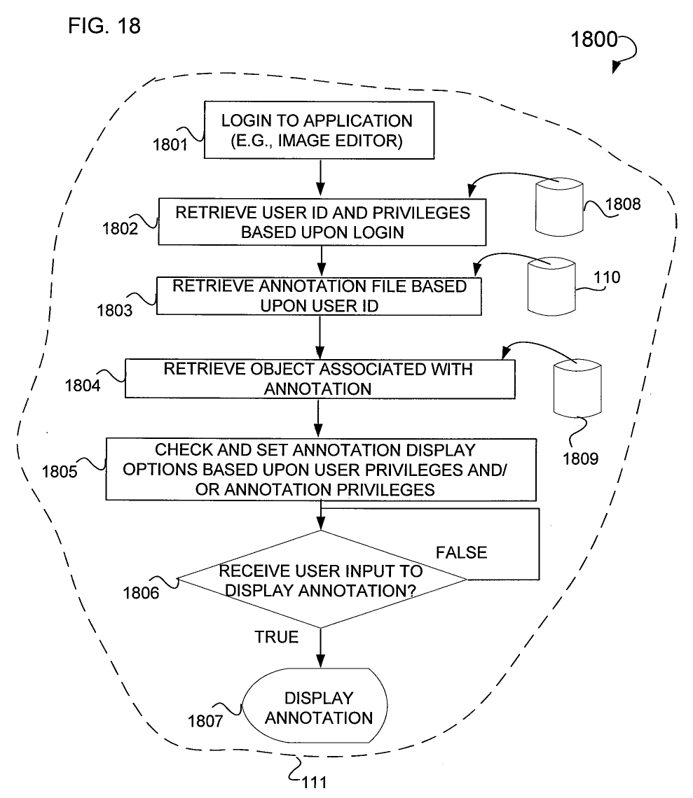

FIG. 18 is a flow chart illustrating the execution of operation 1800 used to display the annotation file 108 within the application interface 115 with annotations. Shown are operations 1801 through 1807 that are executed by the one or more devices 111. Further, shown are databases 1808 and 1809. In some example embodiments, an operation 1801 is executed that requests the user 113 log on to a particular application, whose interface is displayed as a part of the application interface 115 with annotations. An operation 1802 is executed that retrieves a user ID and privileges based upon the log-in values provided at operation 1801. This user ID and privileges is retrieved from the database 1808. An operation 1803 is executed that retrieves the annotation file 108, based upon the user ID, from the annotation database 110. In some example cases, the annotation file 108 is retrieved from the annotation database 203, or some other suitable database that is operatively coupled to the one or more devices 111. An operation 1804 is executed that retrieves an object associated with an annotation from the database 1809. This object may be the object 301. An operation 1805 is executed that checks and sets an annotation display option based upon user privileges and/or annotation privileges. A decisional operation 1806 is executed that determines whether user input has been received to display an annotation. Cases where decisional operation 1806 evaluates to “false,” decisional operation 1806 is re-executed. Cases where decisional operation 1806 evaluates to “true,” the annotation data associated with the annotation file 108 is displayed as part of display 1807. In some example embodiments, the display of the annotation data and additional data associated with the annotation data is displayed based upon certain privileges. These privileges may be included within the annotation file 108, or may be associated with a user ID and stored in the database 1808.

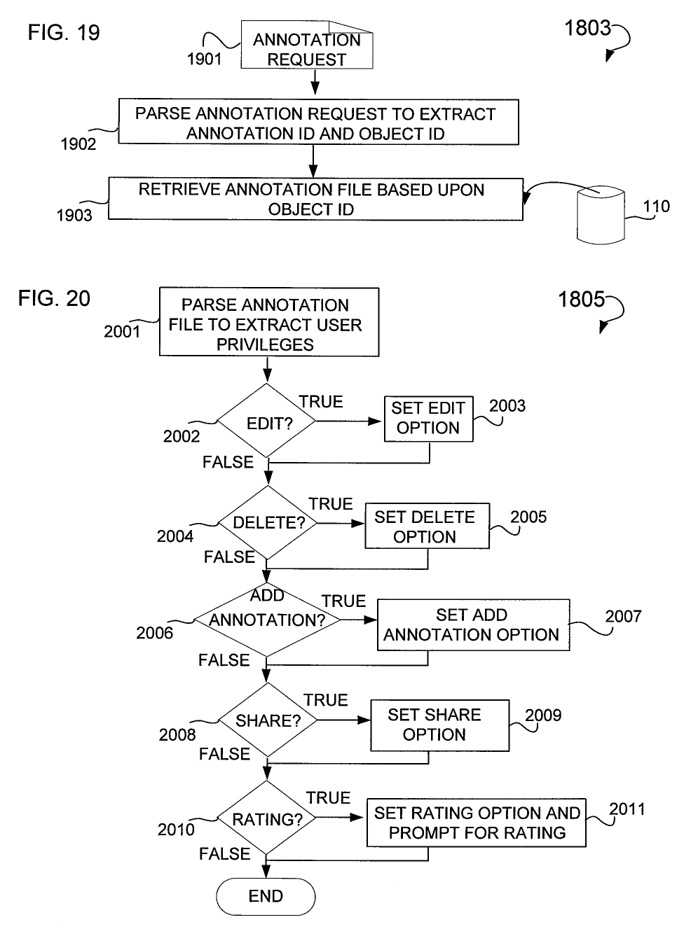

FIG. 19 is a flow chart illustrating the execution of operation 1803, according to an example embodiment. Shown is an annotation request 1901. The annotation request 1901 may be similar to the previously illustrated annotation request 114. An operation 1902 is executed to parse the annotation request 1901, extracting an annotation ID and object ID. An operation 1903 is executed to retrieve the annotation file 108 based upon the object ID from the annotation database 110. In some example embodiments, an annotation is associated with an object ID. Association may include the use of a key value or some other suitable value.

FIG. 20 is a flow chart illustrating the execution of operation 1805, according to an example embodiment. Shown is an operation 2001 that parses an annotation file to extract user privileges, wherein the annotation file may be the annotation file 108. A decisional operation 2002 is executed to determine whether an edit privilege is associated with a user, such as user 113. Where decisional operation 2002 evaluates to “true,” an operation 2003 is executed that sets an edit option for the user 113. Where decisional operation 2002 evaluates to “false,” a decisional operation 2004 is executed. Decisional operation 2004 determines whether a delete privilege may be used by the user 113. Where decisional operation 2004 evaluates to “true,” an operation 2005 is executed that sets a delete option for the user 113. In cases where decisional operation 2004 evaluates to “false,” a decisional operation 2006 is executed. Decisional operation 2006 determines whether or not an add annotation privilege exits for the user 113. In cases where the decisional operation 2006 evaluates to “true,” an operation 2007 is executed that sets a add annotation option for the user 113. In cases where decisional operation 2006 evaluates to “false,” a decisional operation 2008 is executed. Decisional operation 2008 determines whether a share privilege exists for the user 113. In cases where decisional operation 2008 evaluates to “true,” an operation 2009 is executed that sets a share option for the user 113. A share option may relate to the ability of the user 113 to share notes with other users. These other users may be included within a working group or some other type of grouping associated with a corporation structure, such as a business unit. In cases where decisional operation 2008 evaluates to “false,” a decisional operation 2010 is executed. Decisional operation 2010, when executed, determines whether a rating privilege exists for the user 113. In cases where decisional operation 2010 evaluates to “false,” an operation 2011 is executed that sets a rating option for the user 113 and prompts the user 113 to rate particular annotation data and additional data. In cases where decisional operation 2010 evaluates to “false,” a termination condition is executed.

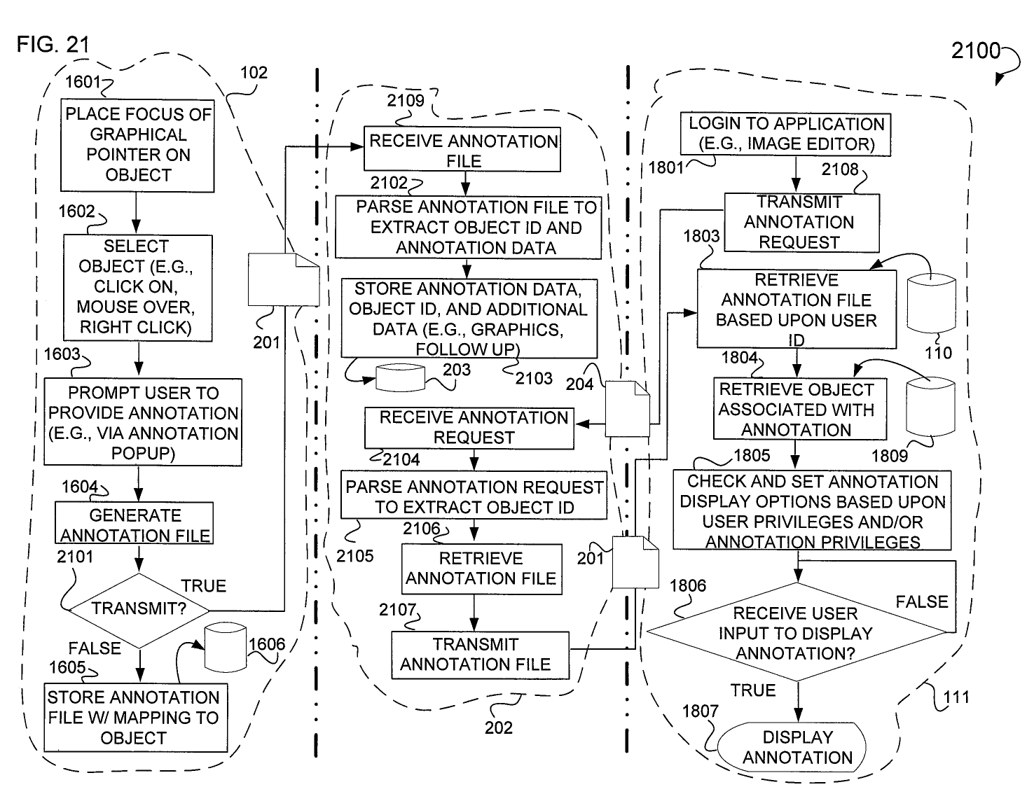

FIG. 21 is a tri-stream flow chart illustrating the execution of a method 2100 used to generate and display the annotation file 201. Shown are operations 1601 through 1605 and a decisional operation 2101 that may be executed by the one or more devices 102. Further shown are operations 2109 and 2102 through 2107 that may be executed by the annotation server 202. Additionally shown are operations 1801, 2108, 1803 through 1807 and a database 1809 that may be executed by the one or more devices 111.

In some example embodiments, operation 1601 is executed to place the focus of the graphical point on an object, such as object 301. An operation 1602 is executed to select the object 301 using a function associated with a graphical pointer. Operation 1603 is executed to prompt a user to provide an annotation in the form of textual or audio-video data. Further, operation 1604 is executed to generate the annotation file 201. A decisional operation 2101 is executed to determine whether to transmit the annotation file 201, or whether to store the annotation file 201 to some type of native or non-native database associated with the one or more devices 102. In cases where decisional operation 2101 evaluates to “false,” an operation 1605 is executed that stores the annotation file 201 with mapping to an object. The storage of the annotation file 201 may be into the database 1606, which may be logically or physically connected to the one or more devices 102. In cases where decisional operation 2101 evaluates to “true,” the annotation file 201 is transmitted and received via the execution of operation 2109. An operation 2102 is executed that parses the annotation file 201 to extract an object ID and annotation data. An operation 2103 is executed that stores the annotation data, object ID and any additional data such as, for example, follow-up data graphics data and privileges data, into the annotation database 203. The user 113 may execute the operation 1801 so as to log on to a software application or otherwise execute a software application using some type of unique identifying password and ID associated with the user 113. An operation 2108 is executed that transmits the annotation request 204. The annotation request 204 is received through the execution of the operation 2104. An operation 2105 is executed that parses the annotation request 204 to extract an object ID. An operation 2106 is executed to retrieve an annotation file 201 from, for example, the annotation database 203 (not pictured). An operation 2107 is executed to transmit the annotation file 201 to be received through the execution of operation 1803.

### Example Database

Some embodiments may include the various databases (e.g., 110, 203, 1606, 1704, 1808, and 1809) being relational databases, or, in some cases, On Line Analytic Processing (OLAP)-based databases. In the case of relational databases, various tables of data are created, and data is inserted into and/or selected from these tables using a Structured Query Language (SQL) or some other database-query language known in the art. In the case of OLAP databases, one or more multi-dimensional cubes or hyper cubes, including multidimensional data from which data is selected from or inserted into using a Multidimensional Expression (MDX) language, may be implemented. In the case of a database using tables and SQL, a database application such as, for example, MYSQL™, MICROSOFT SQL SERVER™, ORACLE 8I™, 10G™, or some other suitable database application may be used to manage the data. In the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. The tables, or cubes made up of tables, in the case of, for example, ROLAP, are organized into an RDS or Object Relational Data Schema (ORDS), as is known in the art. These schemas may be normalized using certain normalization algorithms to avoid abnormalities such as non-additive joins and other problems. Additionally, these normalization algorithms may include Boyce-Codd Normal Form or some other normalization or optimization algorithm known in the art.

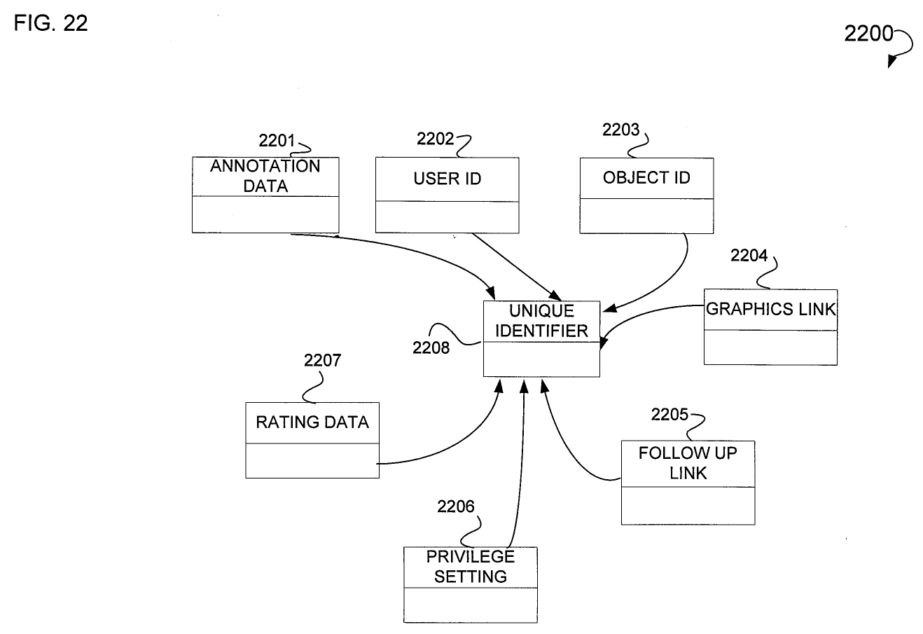

FIG. 22 is an example of RDS 2200. Shown is a table 2201 that includes annotation data. This annotation data may be in the form of text data or some other suitable data that may be stored as, for example, a string, XML or other suitable data type. A table 2202 is also shown that includes a user ID. This user ID may be used to uniquely identify the user 101 or the user 113 via some type of a uniquely identifying alpha-numeric or numeric value. An integer string, XML, or other suitable data type may be used to store the data within table 2202. A table 2203 is shown that includes an object ID. This object ID may be an identifier value in the form of a numeric or alpha-numeric value that may be used to uniquely identify a particular object that is displayed as a part of an application interface (see e.g., object 301). This object ID may be stored as a string, integer, XML, or other suitable data type. A table 2204 is also shown that includes graphics links. These graphics links may be in the form of URL values, or a file formatted as an MPEG, JPEG, SWF, or some other suitable file. The graphics links included within the table 2204 may be stored as, for example, a string, integer, Binary Large Object (BLOB), or some other suitable data type. A table 2205 is shown that includes follow-up link data. This follow-up link data may be a URL that includes follow-up information for the annotation data stored into table 2201. Follow-up links may be stored as a string, integer or XML data type. A table 2206 is shown that includes privilege settings. These privilege settings may describe the settings for certain privileges associated with the annotation data and additional data. These privilege settings may be stored as a Boolean, XML, or other suitable data type. A table 2207 is shown that includes rating data. This rating data may include some type of graphical representation, or other type of representation, of a rating system associated with the annotation data. This rating data may be stored as, for example, some type of string, integer, XML, or other suitable data type. A table 2208 is shown that includes unique identifier values to uniquely identify the various data entries included within the tables 2201 through 2207. An integer data type may be used to uniquely identify the various entries into these tables.

### Distributed Computing Components and Protocols

Some example embodiments may include remote procedure calls being used to implement one or more of the above-illustrated operations (e.g., components) across a distributed programming environment. For example, a logic level may reside on a first computer system that is located remotely from a second computer system including an interface level (e.g., a GUI). These first and second computer systems can be configured in a server-client, peer-to-peer, or some other configuration. The various levels can be written using the above-illustrated component design principles and can be written in the same programming language or in different programming languages. Various protocols may be implemented to enable these various levels and the components included therein to communicate regardless of the programming language used to write these components. For example, an operation written in C++ using Common Object Request Broker Architecture (CORBA) or Simple Object Access Protocol (SOAP) can communicate with another remote module written in Java™. Suitable protocols include SOAP, CORBA, and other protocols well-known in the art.

### A Computer System

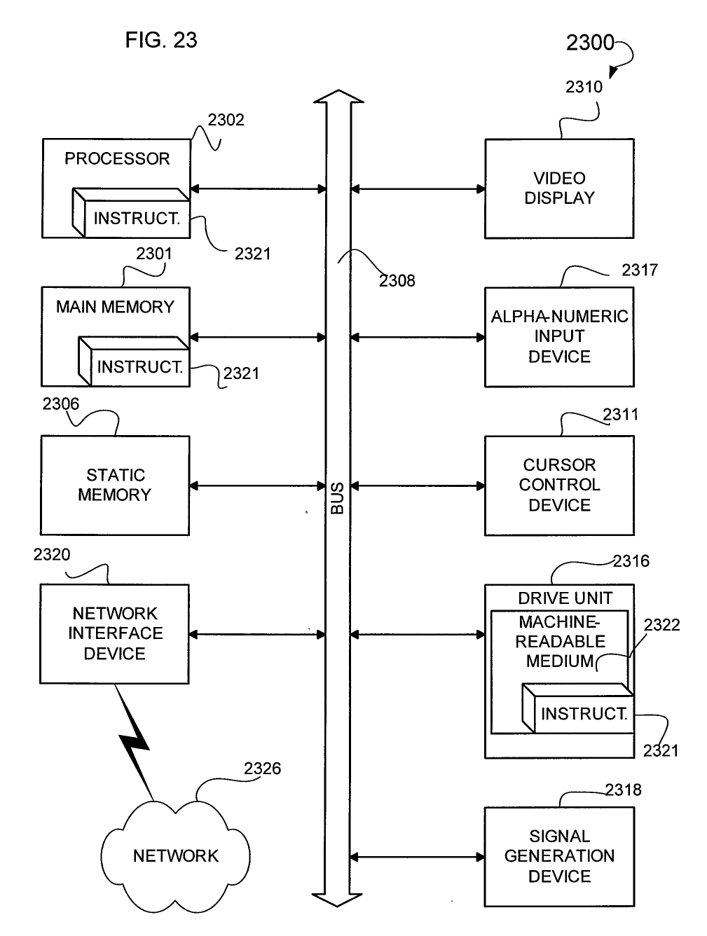

FIG. 23 shows a diagrammatic representation of a machine in the example form of a computer system 2300 that executes a set of instructions to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a Personal Computer (PC), a tablet PC, a Set-Top Box (STB), a PDA, a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 2300 includes a processor 2302 (e.g., a CPU, a Graphics Processing Unit (GPU) or both), a main memory 2301, and a static memory 2306, which communicate with each other via a bus 2308. The computer system 2300 may further include a video display unit 2310 (e.g., a Liquid Crystal Display (LCD) or a Cathode Ray Tube (CRT)). The computer system 2300 also includes an alphanumeric input device 2317 (e.g., a keyboard), a User Interface (UI) (e.g., GUI) cursor control device 2311 (e.g., a mouse), a drive unit 2316, a signal generation device 2318 (e.g., a speaker) and a network interface device (e.g., a transmitter) 2320.

The disk drive unit 2316 includes a machine-readable medium 2322 on which is stored one or more sets of instructions and data structures (e.g., software) 2321 embodying or used by any one or more of the methodologies or functions illustrated herein. The software instructions 2321 may also reside, completely or at least partially, within the main memory 2301 and/or within the processor 2302 during execution thereof by the computer system 2300, the main memory 2301 and the processor 2302 also constituting machine-readable media.

The software instructions 2321 may further be transmitted or received over a network 2326 via the network interface device 2320 using any one of a number of well-known transfer protocols (e.g., Hyper Text Transfer Protocol (HTTP), Secure Hyper Text Transfer Protocol (HTTPS)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies illustrated herein. The term “machine-readable medium” shall accordingly be taken to include, but not be limited to, solid-state memories, optical and magnetic media, and carrier wave signals.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
receiving annotation data relating to an interface object displayed in an application interface, the interface object being selectable to invoke functionality of a software application;
associating, using one or more processors, the annotation data with the interface object;
storing the annotation data as part of an annotation file;
adding an annotation data icon to the application interface at a position proximate a position at which the interface object is displayed in the application interface, the annotation data icon indicating that the interface object is associated with annotation data and
in response to receiving a selection of the annotation data icon, displaying the annotation data in a second application interface superimposed over the application interface, the second application interface including a display of a plurality of textual notes created by a user and associated with the interface object, the second application interface further including a display of a plurality of additional textual notes created by a plurality of additional users and associated with the interface object,

2. The method of claim 1, wherein the annotation data relating to the interface object describes the interface object.

3. The method of claim 2, wherein the annotation data describes a. recommended situation for functionality that is invoked by a selection of the interface object.

4. The method of claim 1, wherein the annotation data includes at least one of textual data, or audio-video data.

5. The method of claim 1, wherein the interface object is presented in a display area of the application interface.

6. The method of claim 1, further comprising displaying the annotation data proximate to the interface object within a display area of the application interface when a graphical pointer is focused on the annotation data icon.

7. The method of claim 1, further comprising:
receiving rating data that provides a user-based rating for the annotation data; and
storing the rating data as part of the annotation file.

8. The method of claim 1, further comprising:
receiving follow-up data that includes additional information relating to the interface object; and
storing the follow-up data as part of the annotation file.

9. The method of claim 8, wherein the follow-up data includes additional information providing specifics with respect to the annotation data.

10. The method of claim 1, further comprising:
receiving graphics data related to the annotation data and
storing the graphics data as part of the annotation file.

11. The method of claim 1, further comprising:
receiving privilege data that sets a user privilege for the annotation data; and
storing the privilege data as part of the annotation file.

12. A method comprising:
receiving an instruction to display annotation data associated with an interface object displayed in an application interface, the interface object being selectable to invoke functionality of a software application, the instruction being a focusing of a graphical pointer on an annotation data icon in the application interface at a position proximate a position at which the interface object is displayed in the application interface;
retrieving, using one or more processors, the annotation data based upon the association of the annotation data with the interface object; and
in response to the instruction, displaying the annotation data in a second application interface superimposed over the application interface, the second application interface including a display of a plurality of text notes created by a user and associated with the interface object, the second application interface further including a display of a plurality of additional textual notes created by a plurality of additional users and associated with the interface object.

13. The method of claim 12, wherein the interface object includes an object presented in the display area, the display area included in a Graphical User Interface (GUI).

14. The method of claim 12, further comprising:
setting a privilege for the annotation data; and
displaying the annotation data proximate to the interface object based upon the privilege.

15. The method of claim 14, wherein the privilege includes at least one of an edit privilege, a delete privilege, an add annotation privilege, a share privilege, or a rating privilege.

16. The method of claim 12, further comprising displaying within the display area at least one of rating data related to the annotation data, additional annotation data generated prior, in time, to the annotation data, follow-up data related to the annotation data, or graphical data related to the annotation data.

17. A computer system comprising:
a receiver to receive annotation data that relates to an interface object displayed in an application interface, the interface object being selectable to invoke functionality of a software application;
an association engine, implemented using one or more processors, to associate the annotation data with the interface object;
a storage engine to store the annotation data as part of an annotation file; and
a display to add an annotation data icon to the application interface at a position proximate a position at which the interface object is displayed in the application interface, the annotation data icon indicating that the interface object is associated with annotation data, and in response to a selection of the annotation data icon, to display the annotation data in a second application interface superimposed over the application interface, the second application interface including a plurality of textual notes created by a user and associated with the interface object, the second application interface further including a display of additional textual notes created by a plurality of additional users and associated with the interface object.

18. The computer system of claim 17, wherein the annotation data relating to the interface object describes the interface object.

19. The computer system of claim 18, wherein the annotation data describes a recommended situation for functionality that is invoked by a selection of the interface object.

20. The computer system of claim 17, wherein the annotation data includes at least one of textual data, or audio-video data.

21. The computer system of claim 17, wherein the interface object is presented in a display area of the application interface.

22. The computer system of claim 17, wherein the display is further to display the annotation data proximate to the interface object within a display area of the application interface when a graphical pointer is focused on the annotation data icon.

23. The computer system of claim 17, further comprising:
an additional receiver to receive rating data that provides a user-based rating for the annotation data; and
an additional storage engine to store rating data as part of the annotation file.

24. The computer system of claim 17, further comprising:
an additional receiver to receive follow-up data that includes additional information relating to the interface object; and
an additional storage engine to store the follow-up data as part of the annotation file.

25. The computer system of claim 24, wherein the follow-up data includes additional information providing specifics with respect to the annotation data.

26. The computer system of claim 17, further comprising:
an additional receiver to receive graphics data related to the annotation data; and
a storage engine to store the graphics data as part of the annotation file.

27. The computer system of claim 17, further comprising:
an additional receiver to receive privilege data that sets a user privilege for the annotation data; and
a storage engine to store the privilege data as part of the annotation file.

28. A computer system comprising:
a receiver to receive an instruction to display annotation data associated with an interface object displayed in an application interface, the interface object being selectable to invoke functionality of a software application, the instruction being a focusing of a graphical pointer on an annotation data icon in the application interface at a position proximate a position at which the interface object is displayed in the application interface;
a retrieving engine, implemented using one or more processors, to retrieve the annotation data based upon the association of the annotation data with the interface object; and
a display to display, in response to receiving the instruction, displaying the annotation data in a second application interface superimposed over the application interface, the second application interface including a display of a plurality of textual notes created by a user and associated with the interface object, the second application interface further including a display of a plurality of additional textual notes created by a plurality of additional users and associated with the interface object.

29. The computer system of claim 28, wherein the interface object includes an object presented in the display area, the display area included in a Graphical User Interface (GUI).

30. The computer system of claim 28, further comprising:
a privilege engine to set a privilege for the annotation data; and
an additional display to display the annotation data proximate to the interface object based upon the privilege.

31. The computer system of claim 30, wherein the privilege includes at least one of an edit privilege, a delete privilege, an add annotation privilege, a share privilege, or a rating privilege.

32. The computer system of claim 28, further comprising an additional display to display within the display area at least one of rating data related to the annotation data, additional annotation data generated prior, in time, to the annotation data, follow-up data related to the annotation data, or graphical data related to the annotation data.

33. An apparatus comprising:
means for receiving annotation data relating to an interface object displayed in an application interface, the interface object being selectable to invoke functionality of a software application;
means for associating the annotation data with the interface object;
means for storing the annotation data as part of an annotation file;
means for adding an annotation data icon to the application interface at a position proximate a position at which the interface object is displayed in the application interface, the annotation data icon indicating that the interface object is associated with annotation data; and
means for, in response to receiving a selection of the annotation data icon, displaying the annotation data in a second application interface superimposed over the application interface, the second application interface including a display of a plurality of textual notes created by a user and associated with the interface object, the second application interface further including a display of a plurality of additional textual notes created by a plurality of additional users and associated with the interface object.

34. A non-transitory machine-readable medium comprising instructions, which when implemented by one or more machines, cause the one or more machines to perform the following operations:
receiving annotation data relating to an interface object displayed in an application interface, the interface object being selectable to invoke functionality of a software application;
associating the annotation data with the interface object;
storing the annotation data as part of an annotation file;
adding an annotation data icon to the application interface at a position proximate a position at which the interface object is displayed in the application interface, the annotation data icon indicating that the interface object is associated with annotation data; and
in response to receiving a selection of the annotation data icon, displaying the annotation data in a second application interface superimposed over the application interface, the second application interface including a display of a plurality of textual notes created by a user and associated with the interface object, second application interface further including a display of a plurality of additional textual notes created by a plurality of additional users and associated with the interface object.
